(19) United States
(12) Patent Application Publication
(10) Pub. No.: US 2021/0304536 A1
(43) Pub. Date: Sep. 30, 2021

(54) DOOR LOCK AND DOOR SYSTEM

(71) Applicant: ZHAOQING CITY ZHISHENG DOOR CONTROL HARDWARE CO., LTD., Zhaoqing (CN)

(72) Inventor: Cheung Choi CHAN, Zhaoqing (CN)

(21) Appl. No.: 17/048,453

(22) PCT Filed: Jul. 24, 2020
(86) PCT No.: PCT/CN2020/104577

§ 371 Date: Oct. 16, 2020

(30) Foreign Application Priority Data
Mar. 26, 2020 (CN) 202010221441

(51) Int. Cl. G07C 9/00; E05B 47/00; E05C 9/02

(52) U.S. Cl. CPC G07C 9/00563; E05C 9/02; E05B 47/0012

(57) ABSTRACT

Disclosed are a door lock and a door system, the door lock includes: a lock body, the lock body including a lock case, a spring bolt assembly and a shifting sleeve, the spring bolt assembly being slidably arranged in the lock case, so as to be able to extend and retract relative to the lock case, the shifting sleeve being rotatably arranged in the lock case, and the shifting sleeve being in transmission connection with the spring bolt assembly; and a first handle assembly, the first handle assembly being provided with a locking head and a motor, the locking head being rotatabversly provided with a shifting head, the shifting head being in transmission connection with the shifting sleeve, and an output shaft of the motor being in transmission connection with the shifting head, so as to be able to drive the shifting head to rotate.

### RELATED APPLICATIONS

This application is a U.S. national phase application of International Pat. App. No. PCT/CN2020/104577, filed on 24 Jul. 2020, which claims priority to Chinese Pat. App. No. 202010221441.X [CN], filed on 26 Mar. 2020. The applications referenced in this paragraph are incorporated by reference as if set forth fully herein.

### TECHNICAL FIELD

The present invention relates to the field of door technologies, and more particularly, to a door system.

### BACKGROUND

A door system usually includes a door frame, a door leaf, a door lock and other parts, wherein the door lock is usually composed of a handle and a lock body, and the lock body is internally provided with a spring bolt and other structures. Some electronic door locks are usually provided with a motor to drive the spring bolt to operate, so as to achieve the purpose of automatic unlocking and locking. In addition, most door locks are also provided with a locking head for unlocking and locking by a key. Generally, the motor is arranged in the lock body, and a transmission structure is correspondingly arranged in the lock body to connect the motor with the spring bolt, so that an internal structure of the lock body is complex, and a thickness and a volume of the lock body are large.

### SUMMARY

The present invention is intended to address at least one of the technical problems in the prior art. For this purpose, the present invention provides a door system, which is able to simplify a structure of a lock body and reduce a thickness and a volume of the lock body.

According to one aspect of the present invention, a door lock is provided, which includes a lock body, the lock body including a lock case, a spring bolt assembly and a shifting sleeve, the spring bolt assembly being slidably arranged in the lock case, so as to be able to extend and retract relative to the lock case, the shifting sleeve being rotatably arranged in the lock case, and the shifting sleeve being in transmission connection with the spring bolt assembly; and

a first handle assembly, the first handle assembly being provided with a locking head and a motor, the locking head being rotatably provided with a shifting head, the shifting head being in transmission connection with the shifting sleeve, and an output shaft of the motor being in transmission connection with the shifting head, so as to be able to drive the shifting head to rotate; and

when a matched key is inserted into the locking head, the shifting head being able to rotate with the key.

The door lock according to the embodiment of the present invention at least has one beneficial effect as follows: the motor is arranged in the first handle assembly, so that the lock body does not need to be provided with the motor and a transmission structure specially adapted with the motor, so as to be able to simplify a structure of the lock body and reduce a thickness and a volume of the lock body; and the key can drive the shifting sleeve to rotate and the motor can drive the shifting sleeve to rotate by connecting the shifting head with the shifting sleeve only, thereby simplifying a transmission chain structure of the whole door lock, decreasing a number of transmission parts, and reducing cost.

According to some embodiments of the present invention, a gear set is arranged between the output shaft of the motor and the shifting head, and the output shaft of the motor is in transmission connection with the shifting head through the gear set.

According to some embodiments of the present invention, the gear set includes a first gear and a second gear, the first gear is fixedly arranged on the output shaft of the motor, the second gear is fixedly arranged on the shifting head, and the first gear is meshed with the second gear.

According to some embodiments of the present invention, the door lock further includes a second handle assembly, wherein a knob assembly is rotatably arranged in the second handle assembly, and the shifting sleeve is in transmission connection with the knob assembly; and the second handle assembly is provided with a locking structure which is able to limit rotation of the knob assembly.

According to some embodiments of the present invention, the door lock further includes a first square rod, wherein one end of the first square rod is inserted into the shifting head, the other end of the first square rod is inserted into the knob assembly, and the first square rod penetrates through the shifting sleeve.

According to some embodiments of the present invention, a side wall of the first square rod is concavely formed with a clearance-avoiding groove;

the locking structure includes a locking block, the locking block is slidably arranged in the second handle assembly, the locking block is provided with a locking hole matched with the first square rod, and the first square rod penetrates through the locking hole; and

when the locking block slides to a position where the clearance-avoiding groove is located in the locking hole, the first square rod is able to rotate relative to the locking block.

According to some embodiments of the present invention, the knob assembly includes a button member, an installation block, a spring member and a hook member; and

the button member is slidably arranged on the installation block, so as to be able to extend and retract relative to the installation block, the spring member is arranged between the installation block and the button member, the button member is provided with a limiting groove bent towards the spring member and a sliding groove communicated with one end of the limiting groove, one end of the hook member is connected with the installation block, and the other end of the hook member is located in the sliding groove.

According to the other aspect of the present invention, a door system is provided, which includes a door opener, a door frame, a door leaf and the door lock according to any one of the claims, wherein one side of the door leaf is rotationally connected with the door frame, and the door lock is arranged on the other side of the door leaf; the door opener connects the door leaf with the door frame; and the door lock is in communication connection with the door opener.

The door system according to the embodiment of the present invention at least has one beneficial effect as follows: after the door lock is unlocked, the door opener may communicate with the door lock to know a state of the door lock, and then the door opener automatically opens the door leaf to realize fully automatic door opening and facilitate use by a user; in addition, the motor is arranged in the first handle assembly, so that the lock body does not need to be provided with the motor and a transmission structure specially adapted with the motor, so as to be able to simplify a structure of the lock body and reduce a thickness and a volume of the lock body; and the key can drive the shifting sleeve to rotate and the motor can drive the shifting sleeve to rotate by connecting the shifting head with the shifting sleeve only, so as to be able to simplify a transmission chain structure of the whole door lock, decrease a number of transmission parts, and reduce a cost.

According to some embodiments of the present invention, the door lock further includes an electronic device and a detection member, wherein

the electronic device includes a signal input module and a main control module, and the signal input module is arranged in the first handle assembly;

the detection member is arranged in the lock case and used for detecting a position of the spring bolt assembly; and

the door opener, the motor, the detection member and the signal input module are all electrically connected with the main control module.

According to some embodiments of the present invention, the electronic device further includes a first communication module arranged in the door lock, the first communication module is electrically connected with the main control module, the door opener is provided with a second communication module, and the second communication module is electrically connected with a main control system on the door opener.

The additional aspects and advantages of the present invention will be partially provided in the following description, and will partially be apparent in the following description, or learned by practice of the present invention.

### BRIEF DESCRIPTION OF THE DRAWINGS

The above and/or additional aspects and advantages of the present invention will be apparent and easily understood from the description of the embodiments with reference to the following accompanying drawings, wherein:

FIG. 1 is a structure diagram of the embodiment of a door system of the present invention;

FIG. 2 is a structure diagram of a door lock;

FIG. 3 is a cross-section view of the door lock shown in FIG. 2;

FIG. 4 is an exploded view of a lock body shown in FIG. 2;

FIG. 5 is an exploded view of a first handle assembly shown in FIG. 2;

FIG. 6 is an exploded view of a second handle assembly shown in FIG. 2 and a structure diagram of a first square rod;

FIG. 7 is a cross-section view of a knob assembly shown in FIG. 6; and

FIG. 8 is a circuit block diagram of the embodiment of the door system.

Reference numerals:

| | |
|---|---|
| 100 | lock body, |
| 110 | lock case, |
| 120 | spring bolt assembly, |
| 121 | spring bolt column, |
| 122 | transmission member, |
| 1221 | guide groove, |
| 123 | first transmission gear, |
| 1231 | shifting block, |
| 130 | shifting sleeve, |
| 131 | second transmission gear, |
| 140 | first square rod, |
| 141 | clearance-avoiding groove, |
| 150 | detection member, |
| 200 | first handle assembly, |
| 210 | first screw, |
| 220 | first handle, |
| 230 | first handle base, |
| 240 | first base plate, |
| 300 | second handle assembly, |
| 310 | second screw, |
| 320 | second handle, |
| 330 | second handle base, |
| 331 | battery compartment, |
| 340 | second base plate, |
| 350 | third screw, |
| 361 | first button, |
| 362 | second button, |
| 400 | electronic device, |
| 410 | signal input module, |
| 411 | fingerprint module, |
| 412 | keyboard, |
| 420 | main control module, |
| 430 | first communication module, |
| 440 | battery module, |
| 510 | locking head, |
| 511 | shifting head, |
| 512 | lock liner, |
| 520 | motor, |
| 530 | gear set, |
| 531 | first gear, |
| 532 | second gear, |
| 610 | knob assembly, |
| 611 | button member, |
| 612 | installation block, |
| 613 | spring member, |
| 614 | hook member, |
| 615 | limiting groove, |
| 616 | sliding groove, |
| 621 | locking block, |
| 622 | locking hole, |
| 710 | door frame, |
| 720 | door leaf, |
| 730 | door opener, and |
| 731 | second communication module. |

### DETAILED DESCRIPTION

The embodiments of the present invention are described in detail hereinafter. Examples of the embodiments are shown in the accompanying drawings. The same or similar reference numerals throughout the accompanying drawings denote the same or similar elements or elements having the same or similar functions. The embodiments described hereinafter with reference to the accompanying drawings are exemplary and are only used to explain the present invention, but should not be understood as limiting the present invention.

In the description of the present invention, if the terms “first” and “second” are used for the purpose of distinguishing the technical features only in the description, and cannot be understood as indicating or implying relative importance, implicitly indicating the number of technical features indicated thereby, or implicitly indicating the order of technical features indicated thereby.

In the description of the present invention, the terms arrangement, installation, connection and the like should be understood in broad sense unless otherwise specified and defined. The specific meanings of the above terms in the present invention may be reasonably determined according to specific contents of the technical solutions by those skilled in the art.

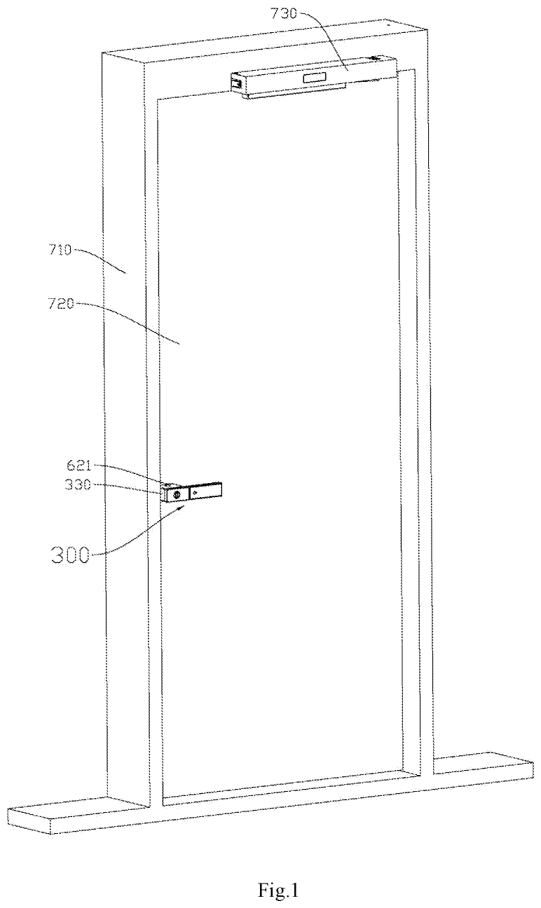

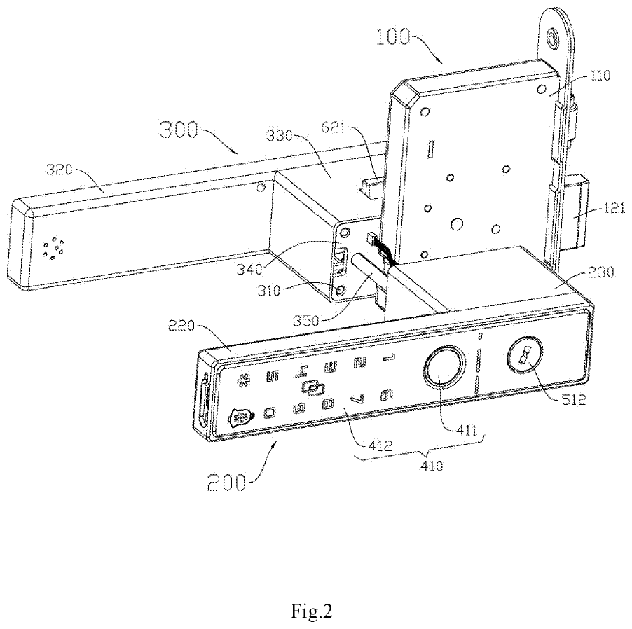

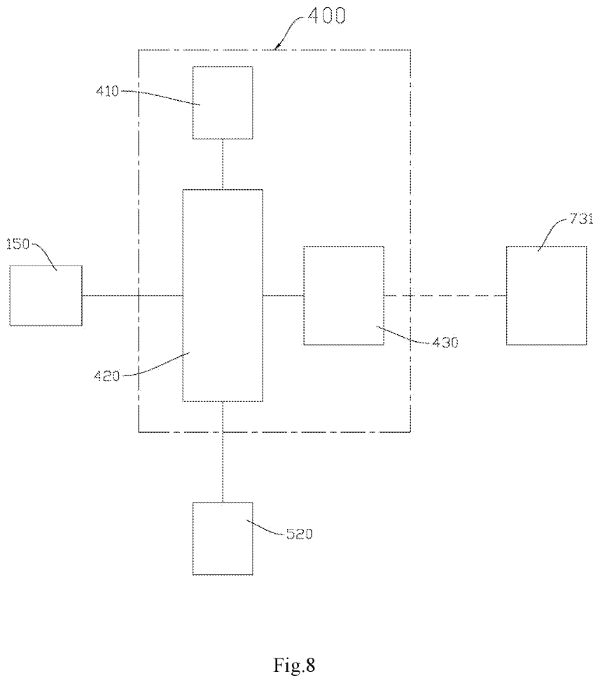

As shown in FIG. 1 to FIG. 8, a door system according the embodiment of the present invention includes a door frame 710, a door leaf 720, a door lock and a door opener 730.

One side of the door frame 710 is rotatably connected with the door leaf 720 through a hinge, a bisagra or other structures, and the door lock is arranged on the other side of the door leaf 720. The door opener 730 connects the door frame 710 with the door leaf 720, and when the door opener 730 is operated, the door leaf 720 may be pushed to rotate to realize automatic door opening. The door lock includes a lock body 100, a first handle assembly 200, a second handle assembly 300, an electronic device 400 and a first square rod 140.

The lock body 100 includes a lock case 110, a spring bolt assembly 120 and a shifting sleeve 130. The spring bolt assembly 120 is slidably arranged in the lock case 110, so that the spring bolt assembly 120 is able to extend and retract relative to the lock case 110. The shifting sleeve 130 is rotatably arranged in the lock case 110, and the shifting sleeve 130 is in transmission connection with the spring bolt assembly 120. The first handle assembly 200 is provided with a locking head 510 and a motor 520. The locking head 510 is rotatably provided with a shifting head 511, and the shifting head 511 is in transmission connection with the shifting sleeve 130. An output shaft of the motor 520 is in transmission connection with the shifting head 511. The electronic device 400 includes a signal input module 410 and a main control module 420. The signal input module 410 is arranged in the first handle assembly 200, the main control module 420 may be arranged in the first handle assembly 200, and the signal input module 410 and the motor 520 are both electrically connected with the main control module 420. The signal input module 410 includes a fingerprint module 411 and a keyboard 412.

When a key is used to unlock the lock, a matched key is inserted into the locking head 510, and then the key is rotated forwardly. The shifting head 511 may rotate with the key, and the shifting sleeve 130 may rotate with the shifting head 511, thus driving the spring bolt assembly 120 to slide and retract into the lock case 110. When the key is used to lock the lock, the matched key is inserted into the locking head 510, and then the key is rotated reversely. When the lock is unlocked by a fingerprint or a password, a correct fingerprint or password is inputted through the signal input module 410, the main control module 420 controls the motor 520 to operate, the output shaft of the motor 520 rotates forwardly, and the shifting head 511 may rotate with the output shaft of the motor 520, thus driving the spring bolt assembly 120 to slide and retract into the lock case 110. When the lock needs to be locked, the main control module 420 controls the motor 520 to operate, so that the output shaft of the motor 520 rotates reversely.

As above, the motor 520 is arranged in the first handle assembly 200, and the motor 520 drives the spring bolt assembly 120 to slide through the shifting head 511 on the locking head 510, so that the lock body 100 does not need to be provided with the motor 520 and a transmission structure specially adapted with the motor 520, so as to be able to simplify a structure of the lock body 100 and reduce a thickness and a volume of the lock body 100.

In some embodiments, the main control module 420 may also be arranged in the second handle assembly 300.

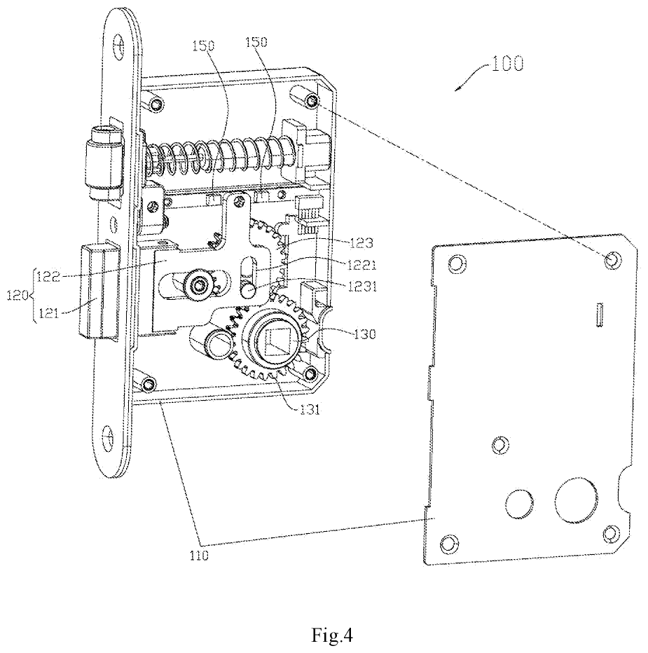

Referring to FIG. 4, the spring bolt assembly 120 includes a spring bolt column 121 and a transmission member 122. The spring bolt column 121 and the transmission member 122 are fixedly connected, the transmission member 122 is provided with a guide groove 1221, and the guide groove 1221 is staggered with a sliding direction of the spring bolt assembly 120. The lock case 110 is rotatably provided with a first transmission gear 123, the first transmission gear 123 is provided with a shifting block 1231, and the shifting block 1231 is inserted into the guide groove 1221. The first transmission gear 123 is meshed with the shifting sleeve 130 for transmission, which means that the shifting sleeve 130 is provided with a second transmission gear 131, and the second transmission gear 131 is meshed with the first transmission gear 123, so that the shifting sleeve 130 is in transmission connection with the spring bolt assembly 120. A position of the shifting block 1231 deviates from an axis of the first transmission gear 123, and the first transmission gear 123 rotates around the axis, so that the shifting block 1231 may slide along the guide groove 1221 when the first transmission gear 123 rotates, thus pushing the spring bolt assembly 120 to slide.

In some embodiments, the transmission member 122 may also be provided with a rack, and the second transmission gear 131 on the shifting sleeve 130 is meshed with the rack, so that the shifting sleeve 130 is in transmission connection with the spring bolt assembly 120.

The door lock further includes a detection member 150. Referring to FIG. 4, the detection member 150 is arranged in the lock case 110. The detection member 150 is electrically connected with the main control module 420, and the detection member 150 is used for detecting a position of the spring bolt assembly 120. When the spring bolt assembly 120 extends and retracts to a limit position, the detection member 150 may be triggered. After the detection member 150 is triggered, a trigger signal is sent to the main control module 420, so that the main control module 420 may control the motor 520 to stop operating in time. The detection member 150 may be set as a Hall element for detecting a magnetic field strength, and correspondingly, a magnetic block is arranged on the spring bolt assembly 120. In addition, the detection member 150 may also be set as a photoelectric switch, a limiting switch or other structures.

A gear set 530 is arranged between the output shaft of the motor 520 and the shifting head 511, and the output shaft of the motor 520 is in transmission connection with the shifting head 511 through the gear set 530. When the output shaft of the motor 520 rotates, the shifting head 511 may be driven to rotate by the gear set 530.

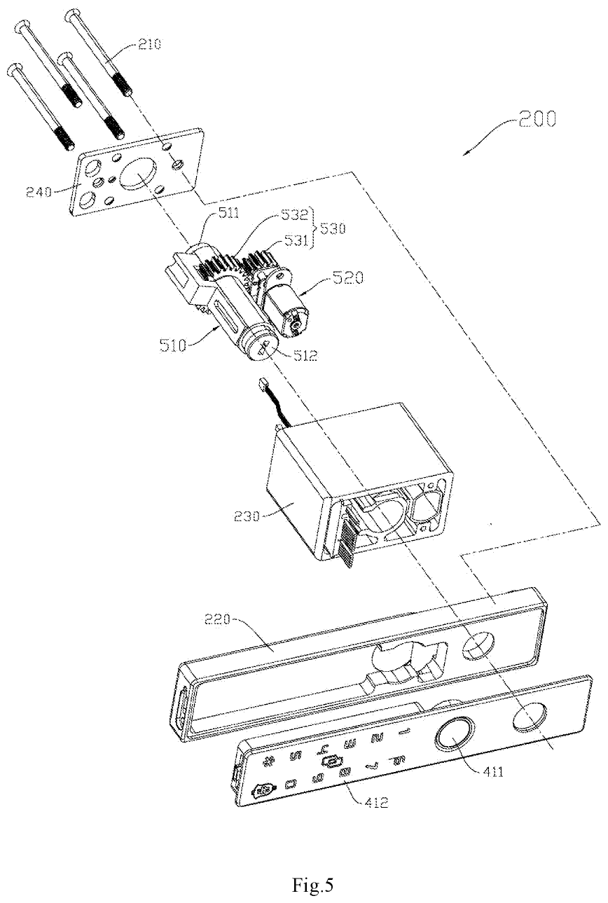

For example, referring to FIG. 5, the gear set 530 includes a first gear 531 and a second gear 532. The first gear 531 is fixedly arranged on the output shaft of the motor 520, the second gear 532 is fixedly arranged on the shifting head 511, and the first gear 531 is meshed with the second gear 532. The first gear 531 and the second gear 532 are both set as spur gears, and a rotation axis of the shifting head 511 is parallel to an axis of the output shaft of the motor 520. Certainly, in some embodiments, the first gear 531 and the second gear 532 are both set as bevel gears, so that an included angle may be formed between a rotation axis of the shifting head 511 and the axis of the output shaft of the motor 520, and an installation orientation of the motor 520 has a greater flexibility.

In some embodiments, the gear set 530 may further include a third gear. The third gear is rotatably arranged in the first handle assembly 200, and the first gear 531, the third gear and the second gear 532 are sequentially meshed.

In some embodiments, the output shaft of the motor 520 may also be in transmission connection with the shifting head 511 through a belt structure or a coupler, so that the motor 520 is able to drive the shifting head 511 to rotate.

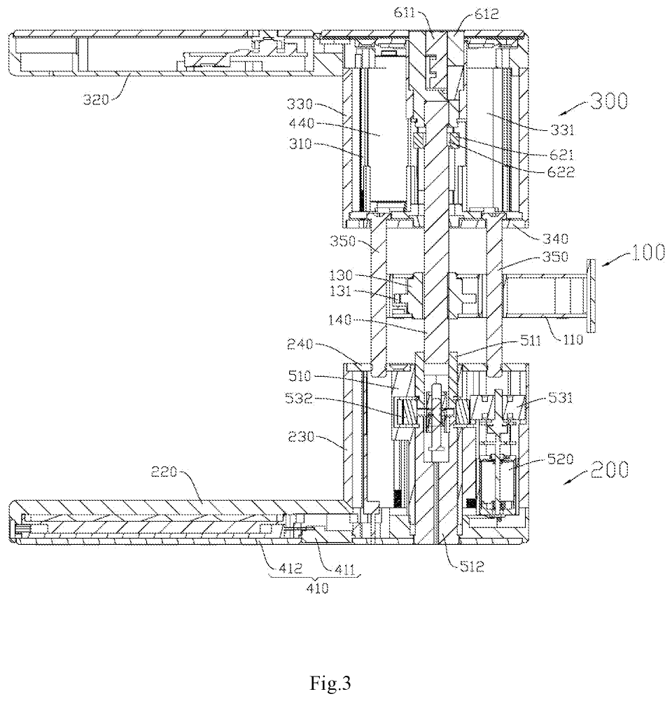

Referring to FIG. 3, one end of the first square rod 140 is inserted into the shifting head 511, and the first square rod 140 also penetrates through the shifting sleeve 130, so that the shifting head 511 may be in transmission connection with the shifting sleeve 130. When the shifting head 511 rotates, the shifting sleeve 130 may be driven to rotate by the first square rod 140. A part of one end of the first square rod 140 near the shifting head 511 may be cut off according to the thickness of the door leaf 720 during installation, so as to make a length of the first square rod 140 match with the thickness of the door leaf 720.

In some embodiments, the shifting head 511 and the shifting sleeve 130 may also be connected by the coupler and other structures.

Referring to FIG. 5, the first handle assembly 200 includes a first screw 210, as well as a first handle 220, a first handle base 230 and a first base plate 240 arranged in sequence. The first handle base 230 is set to have a hollow structure. The first screw 210 penetrates through the first base plate 240 and the first handle base 230, and the first screw 210 is in screwed connection with the first handle 220 to sandwich the first handle base 230 between the first handle 220 and the first base plate 240. The motor 520 and the locking head 510 are both inserted into an inner cavity of the first handle base 230, and the signal input module 410 is arranged in the first handle 220. The motor 520 and the locking head 510 may be inserted into the first handle base 230 first, and then the first handle assembly 200 is assembled through the structure during assembling, so that assembly of the first handle assembly 200 is relatively simple. The first handle assembly 200 has a small-sized single part and a simple structure, thus being convenient for processing.

The second handle assembly 300 is rotatably provided with a knob assembly 610, and the shifting sleeve 130 is in transmission connection with the knob assembly 610, so that the shifting sleeve 130 is able to rotate with the knob assembly 610. The second handle assembly 300 is also provided with a locking structure matched with the knob assembly 610, and rotation of the knob assembly 610 is able to be restricted by the locking structure, so as to play a role of double locking inside a door.

The other end of the first square rod 140 is inserted into the knob assembly 610, so that the knob assembly 610 may be in transmission connection with the shifting sleeve 130.

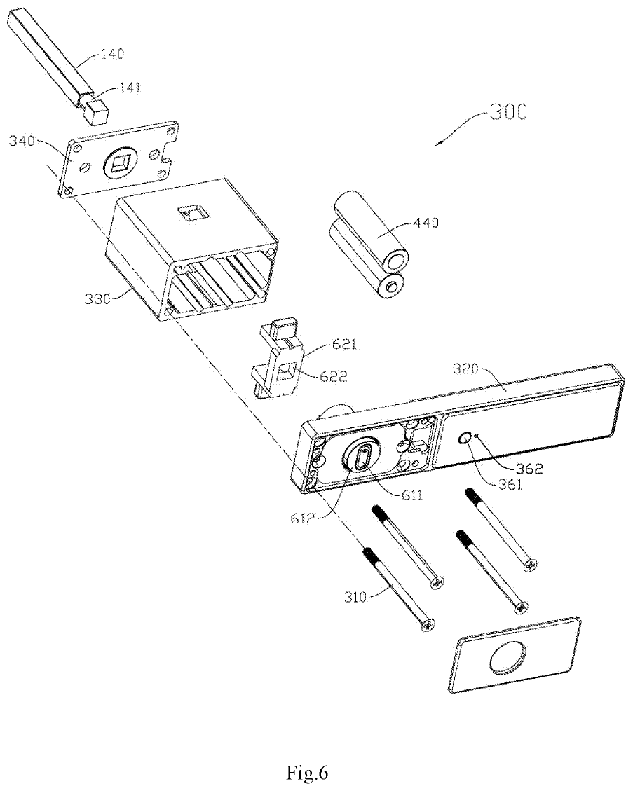

For example, referring to FIG. 3 and FIG. 6, a side wall of the first square rod 140 is concavely formed with a clearance-avoiding groove 141. The locking structure includes a locking block 621, the locking block 621 is slidably arranged in the second handle assembly 300, and the locking block 621 is provided with a locking hole 622 matched with the first square rod 140. The first square rod 140 penetrates through the locking hole 622, which means that the locking block 621 is sleeved on the first square rod 140.

When the double locking inside the door is needed, the spring bolt assembly 120 is driven to slide out of the lock case 110 first, so that the spring bolt assembly 120 is inserted into the door frame 720, and then the locking block 621 is pushed and pressed, so that the clearance-avoiding groove 141 is staggered with the locking hole 622. At the moment, the first square rod 140 is matched with the locking hole 622, and the knob assembly 610 and the first square rod 140 cannot rotate, so that the shifting sleeve 130 cannot rotate either. At the moment, neither the key nor the motor 520 can unlock the lock. The locking block 621 is pushed to move, so that the clearance-avoiding groove 141 is located in the locking hole 622. At the moment, the first square rod 140 is no longer matched with the locking hole 622, and the first square rod 140 is able to rotate relative to the locking hole 622. At the moment, the shifting sleeve 130 may be driven to rotate by rotating the knob assembly 610, and the shifting sleeve 130 may also be driven to rotate by the motor 520 or the key.

In some embodiments, the locking structure may include the locking block 621 and a limiting column. An end surface of the knob assembly 610 facing the lock body 100 is provided with a limiting hole, and the locking block 621 is provided with the limiting column. When the locking block 621 is pushed to slide, so that the limiting column is inserted into the limiting hole, the rotation of the knob assembly 610 may be restricted. When the limiting column moves out of the limiting hole, the knob assembly 610 may rotate. The limiting column is preferably tapered, so as to facilitate guiding insertion of the limiting column into the limiting hole.

In some embodiments, one end of the first square rod 140 may be inserted into the shifting head 511, and the other end of the first square rod 140 is inserted into or fixedly connected with the shifting sleeve 130. In addition, a second square rod is provided, one end of the second square rod is inserted into or fixedly connected with the knob assembly 610, and the other end of the second square rod is inserted into or fixedly connected with the shifting sleeve 130.

Referring to FIG. 3 and FIG. 6, the second handle assembly 300 includes a second screw 310, a second handle 320, a second handle base 330 and a second base plate 340. The second handle base 330 is set to have a hollow structure. The second base plate 340, the second handle base 330 and the second handle 320 are arranged in sequence, the second screw 310 penetrates through the second handle base 320 and the second handle base 330, and the second screw 310 is screwed into the second base plate 340. The second handle assembly 300 may be assembled through the structure during assembly, so that the assembly of the second handle assembly 300 is relatively simple. The second handle assembly 300 has a small-sized single part and a simple structure, thus being convenient for processing.

The second handle base 330 is internally provided with a battery compartment 331, and a battery module 440 may be installed in the battery compartment 331. Power may be supplied to the electronic device 400, the motor 520 and other electrical components through the battery module 440.

As an installation method of the door lock, the lock body 100 may be embedded in the door leaf 720 first, the second base plate 340 is arranged on an inner surface of the door leaf 720, and the assembled first handle assembly 200 is arranged outside the door leaf 720. The third screw 350 penetrates through the second base plate 340 and the lock body 100 in sequence, and the third screw 350 is screwed into the first base plate 240, and then the second handle assembly 300 is assembled.

The locking head 510 is also provided with a lock liner 512. When the key is not inserted into the lock liner 512, the lock liner 512 is clamped to the locking head 510 and cannot be rotated. When the matched key is inserted into the lock liner 512, the lock liner 512 may be released from clamping. At the moment, the key and the lock liner 512 are able to be rotated. After the key is inserted into the lock liner 512, an end portion of the key may be directly inserted into the shifting block 1231, or a transmission block is slidably arranged on the locking head 510. When the key is not inserted into the lock liner 512, the transmission block is only inserted into the lock liner 512. After the key is inserted into the lock liner 512, the transmission block is pushed to move, so that the transmission block is simultaneously inserted into the lock liner 512 and the shifting block 1231. In this way, the shifting block 1231 is able to rotate with the matched key.

Certainly, the embodiment of the present invention is not limited to the above locking head 510, and those skilled in the art may also adopt locking heads 510 with other structures.

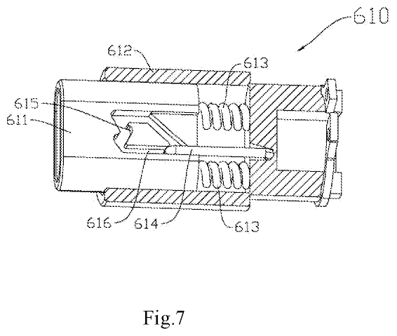

Referring to FIG. 7, the knob assembly 610 includes a button member 611, an installation block 612, a spring member 612 and a hook member 614. The installation block 612 is rotatably inserted into the second handle assembly 300, and the button member 611 is slidably inserted into the installation block 612, so that the button member 611 is able to extend from and retract into the installation block 612. The spring member 613 is arranged between the installation block 612 and the button member 611, and the button member 611 is provided with a limiting groove 615 bent towards the spring member 613 and a sliding groove 616 communicated with one end of the limiting groove 615. One end of the hook member 614 is connected with the installation block 612, and the other end of the hook member 614 is located in the sliding groove 616. The hook member 614 is rotatably inserted into the installation block 612, so that the hook member 614 is able to swing relative to the installation block 612, or the hook member 614 is fixedly connected with the installation block 612. The hook member 614 itself is able to be elastically bent and deformed under an action of an external force, so that the hook member 614 is able to swing relative to the installation block 612.

The limiting groove 615 may be V-shaped specifically. In addition, the limiting groove 615 may also be U-shaped or arc-shaped.

The button member 611 may move towards the installation block 612 by pressing the button member 611 during use. An end portion of the hook member 614 moves into the limiting groove 615 along the sliding groove 616, and the button member 611 is released to enable to the hook member 614 to be hung in the limiting groove 615, so that the button member 611 is able to retract into the installation block 612, thus making the second handle assembly 300 beautiful. The button member 611 is pressed again to enable the end portion of the hook member 614 to slide out to the sliding groove 616 along the limiting groove 615, the button member 611 is released, and the spring member 613 may push the button member 611 to extend out. The end portion of the hook member 614 slides along the sliding groove 616, so that the user may rotate the button member 611 and drive the knob assembly 610 to rotate.

As described above, in the embodiment of the present invention, the locking head 510 and the motor 520 share the first square rod 140, and only the first square rod 140 needs to be arranged between the first handle assembly 200 and the lock body 100 to realize unlocking and locking in two power modes of key driving and motor 520 driving. A structure thereof is simple, without an additional transmission structure to connect the motor 520 with the shifting sleeve 130, so as to be able to simplify a transmission chain structure of the whole door lock, decrease a number of transmission parts, and reduce a cost.

In the embodiment of the present invention, the main control module 420 is in communication connection with the door opener 730, which means that the door lock is able to send a door opening signal to the door opener 730, and after the door opener 730 receives the door opening signal, the door opener 730 is operated to open the door automatically.

For example, the electronic device 300 further includes a first communication module 430 arranged in the second handle assembly 300, and the first communication module 430 is electrically connected with the main control module 420. The door opener 730 is provided with a second communication module 731, and the second communication module 731 is electrically connected with a main control system on the door opener 730. As a working mode, after the user inputs a correct fingerprint, password or iris through the signal input module 410, the main control module 420 controls the motor 520 to operate, so that the spring bolt assembly 120 retracts into the lock case 110. When the spring bolt assembly 120 retracts to the limit position, the detection member 150 is triggered and feeds a trigger signal back to the main control module 420. After receiving the trigger signal, the main control module 420 sends the door opening signal to the second communication module 731 through the first communication module 430, the second communication module 731 receives the door opening signal and feeds the door opening signal back to the main control system of the door opener 730, and the main control system controls the door opener 730 to open the door.

In some embodiments, the second communication module 731 may be arranged outside the door opener 730, which means that the second communication module 731 is not located on the door opener 730, and the second communication module 731 is electrically connected with the main control system of the door opener 730 through a wire and other structures. In addition, in some embodiments, the first communication module 430 may also be arranged in the first handle assembly 200.

In this way, when the user inputs the correct fingerprint or password through the signal input module 410, the door system is able to operate automatically, thus realizing fully automatic door opening and facilitating use by the user.

Referring to FIG. 6, the second handle assembly 300 is provided with a first button 361 and a second button 362, and both the first button 361 and the second button 362 are electrically connected with the main control module 420. When needing to open the door inside the door, the user may press the first button 361. After the first button 361 is pressed and triggered, the main control module 420 controls the motor 520 to operate and sends the door opening signal to the second communication module 731 through the first communication module 430, thus achieving the purpose of opening the door with one button and facilitating use by the user. When the user presses the second button 362, the door lock may enter a setting mode, thus being convenient for the user to set some information, such as inputting the fingerprint and changing the password. The first button 361 and the second button 362 may be a button switch or other structures.

Certainly, the present invention is not limited to the above embodiments. Those skilled in the art may further make various equivalent modifications or substitutions without violating the spirit of the present invention, and these equivalent modifications or substitutions are all included in the scope defined by the claims of the present application.

1. A door lock, comprising:
a lock body (100), the lock body (100) comprising a lock case (110), a spring bolt assembly (120) and a shifting sleeve (130), the spring bolt assembly (120) being slidably arranged in the lock case (110), so as to be able to extend and retract relative to the lock case (110), the shifting sleeve (130) being rotatably arranged in the lock case (110), and the shifting sleeve (130) being in transmission connection with the spring bolt assembly (120); and
a first handle assembly (200), the first handle assembly (200) being provided with a locking head (510) and a motor (520), the locking head (510) being rotatably provided with a shifting head (511), the shifting head (511) being in transmission connection with the shifting sleeve (130), and an output shaft of the motor (520) being in transmission connection with the shifting head (511), so as to be able to drive the shifting head (511) to rotate, and when a matched key being inserted into the locking head (510), the shifting head (511) being able to rotate with the key.

2. The door lock of claim 1, wherein: a gear set (530) is arranged between the output shaft of the motor (520) and the shifting head (511), and the output shaft of the motor (520) is in transmission connection with the shifting head (511) through the gear set (530).

3. The door lock of claim 2, wherein: the gear set (530) comprises a first gear (531) and a second gear (532), the first gear (531) is fixedly arranged on the output shaft of the motor (520), the second gear (532) is fixedly arranged on the shifting head (511), and the first gear (531) is meshed with the second gear (532).

4. The door lock of claim 1, further comprising a second handle assembly (300), wherein: a knob assembly (610) is rotatably arranged in the second handle assembly (300), and the shifting sleeve (130) is in transmission connection with the knob assembly (610); and the second handle assembly (300) is provided with a locking structure which is able to limit rotation of the knob assembly (610).

5. The door lock of claim 4, further comprising a first square rod (140), wherein one end of the first square rod (140) is inserted into the shifting head (511), the other end of the first square rod (140) is inserted into the knob assembly (610), and the first square rod (140) penetrates through the shifting sleeve (130).

6. The door lock of claim 5, wherein:
a side wall of the first square rod (140) is concavely formed with a clearance-avoiding groove (141);
the locking structure comprises a locking block (621), the locking block (621) is slidably arranged in the second handle assembly (300), the locking block (621) is provided with a locking hole (622) matched with the first square rod (140), and the first square rod (140) penetrates through the locking hole (622); and
when the locking block (621) slides to a position where the clearance-avoiding groove (141) is located in the locking hole (622), the first square rod (140) is able to rotate relative to the locking block (621).

7. The door lock of claim 4, wherein:
the knob assembly (610) comprises a button member (611), an installation block (612), a spring member (613) and a hook member (614); and
the button member (611) is slidably arranged on the installation block (612), so as to be able to extend and retract relative to the installation block (612), the spring member (613) is arranged between the installation block (612) and the button member (611), the button member (611) is provided with a limiting groove (615) bent towards the spring member (613) and a sliding groove (616) communicated with one end of the limiting groove (615), one end of the hook member (614) is connected with the installation block (612), and the other end of the hook member (614) is located in the sliding groove (616).

8. A door system, comprising:
a door opener (730);
a door frame (710);
a door leaf (720); and
a door lock, comprising:
a lock body (100), the lock body (100) comprising a lock case (110), a spring bolt assembly (120) and a shifting sleeve (130), the spring bolt assembly (120) being slidably arranged in the lock case (110), so as to be able to extend and retract relative to the lock case (110), the shifting sleeve (130) being rotatably arranged in the lock case (110), and the shifting sleeve (130) being in transmission connection with the spring bolt assembly (120); and
a first handle assembly (200), the first handle assembly (200) being provided with a locking head (510) and a motor (520), the locking head (510) being rotatably provided with a shifting head (511), the shifting head (511) being in transmission connection with the shifting sleeve (130), and an output shaft of the motor (520) being in transmission connection with the shifting head (511), so as to be able to drive the shifting head (511) to rotate, and when a matched key being inserted into the locking head (510), the shifting head (511) being able to rotate with the key;
wherein one side of the door leaf (720) is rotationally connected with the door frame (710), and the door lock is arranged on the other side of the door leaf (720), the door opener (730) connects the door leaf (720) with the door frame (710), and the door lock is in communication connection with the door opener (730).

9. The door system of claim 8, wherein the door lock further comprises an electronic device (400) and a detection member (150), wherein:
the electronic device (400) comprises a signal input module (410) and a main control module (420), and the signal input module (410) is arranged in the first handle assembly (200); the detection member (150) is arranged in the lock case (110) and used for detecting a position of the spring bolt assembly (120); and
the door opener (730), the motor (520), the detection member (150) and the signal input module (410) are all electrically connected with the main control module (420).

10. The door system of claim 9, wherein the electronic device (400) further comprises a first communication module (430) arranged in the door lock, the first communication module (430) is electrically connected with the main control module (420), the door opener (730) is provided with a second communication module (731), and the second communication module (731) is electrically connected with a main control system on the door opener (730).
